(19) United States
(12) Patent Application Publication
(10) Pub. No.: US 2014/0011519 A1
(43) Pub. Date: Jan. 9, 2014

(54) METHOD FOR TRANSMITTING LOCATION INFORMATION AND USER EQUIPMENT

(71) Applicants: Youngdae Lee, Anyang-si (KR); Sunghoon Jung, Anyang-si (KR); Seungjune Yi, Anyang-si (KR); Sungduck Chun, Anyang-si (KR); Sungjun Park, Anyang-si (KR)

(72) Inventors: Youngdae Lee, Anyang-si (KR); Sunghoon Jung, Anyang-si (KR); Seungjune Yi, Anyang-si (KR); Sungduck Chun, Anyang-si (KR); Sungjun Park, Anyang-si (KR)

(73) Assignee: LG ELECTRONICS INC., Seoul (KR)

(21) Appl. No.: 14/005,761

(22) PCT Filed: Apr. 3, 2012
(86) PCT No.: PCT/KR12/02476

§ 371 Date: Sep. 17, 2013

Related U.S. Application Data
(60) Provisional application No. 61/471,177, filed on Apr. 3, 2011.

(51) Int. Cl. H04W 64/00

(52) U.S. Cl. CPC H04W 64/00
USPC 455/456.1

(57) ABSTRACT

The present invention provides a method and an apparatus for detecting an approaching cell, which is different from a cell (hereinafter referred to as serving cell) in which the user equipment stays, and transmitting location information, which indicates the location of the user equipment, to a network. According to the present invention, a network can easily identify cell coverage.

### TECHNICAL FIELD

The present invention relates to a wireless communication system and, more particularly, to a method and apparatus for transmitting positioning information regarding coverage of a cell to a network and a method and apparatus for receiving the positioning information.

### BACKGROUND ART

As an example of a wireless communication system to which the present invention is applicable, a 3rd generation partnership project long term evolution (3GPP LTE) communication system is described in brief

FIG. 1 is a view schematically illustrating a network structure of an E-UMTS as an exemplary radio communication system. An evolved universal mobile telecommunications system (E-UMTS) is an advanced version of a conventional universal mobile telecommunications system (UMTS) and basic standardization thereof is currently underway in the 3GPP. E-UMTS may be generally referred to as a long term evolution (LTE) system. For details of the technical specifications of the UMTS and E-UMTS, reference can be made to Release 7 and Release 8 of the 3rd generation partnership project (3GPP) technical specification (TS), respectively.

Referring to FIG. 1, the E-UMTS includes a user equipment (UE), eNode Bs (eNBs), and an access gateway (AG) which is located at an end of a network (Evolved Universal Terrestrial Radio Access Network (E-UTRAN)) and connected to an external network. The eNBs may simultaneously transmit multiple data streams for a broadcast service, a multicast service, and/or a unicast service.

One eNB manages one or more cells. A cell is configured to use one of bandwidths of 1.25, 2.5, 5, 10, and 20 MHz to provide a downlink or uplink transport service to several UEs. Different cells may be set to provide different bandwidths. The eNB controls data transmission and reception for one or more UEs. The eNB transmits downlink scheduling information with respect to downlink data to notify a corresponding UE of a time/frequency region in which data is to be transmitted, coding, data size, and hybrid automatic repeat and request (HARQ)-related information. In addition, the eNB transmits uplink scheduling information with respect to uplink data to a corresponding UE to inform the UE of an available time/frequency region, coding, data size, and HARQ-related information. An interface may be used for transmission of user traffic or control traffic between eNBs. A core network (CN) may include the AG, a network node for user registration of the UE, and the like. The AG manages mobility of a UE on a tracking area (TA) basis, each TA including a plurality of cells.

Although radio communication technology has been developed up to 3GPP LTE(-A) based on wideband code division multiple access (WCDMA), demands and expectations of users and providers continue to increase. In addition, since other radio access technologies continue to be developed, new advances in technology are required to secure future competitiveness. Decrease of cost per bit, increase of service availability, flexible use of a frequency band, simple structure, open interface, and suitable power consumption by a UE are required.

### DISCLOSURE

### Technical Problem

The present invention provides a method and apparatus for transmitting positioning information regarding coverage of a cell to a network and a method and apparatus for receiving the positioning information.

It will be appreciated by persons skilled in the art that that the technical objects that can be achieved through the present invention are not limited to what has been particularly described hereinabove and other technical objects of the present invention will be more clearly understood from the following detailed description.

### Technical Solution

As an aspect of the present invention, provided herein is a method for transmitting positioning information to a network at a user equipment in a wireless communication system, including detecting proximity of a cell other than a cell (hereinafter, a serving cell) in which the user equipment stays, acquiring position of the user equipment, and transmitting positioning information indicating the acquired position to the network.

As another aspect of the present invention, provided herein is a user equipment for transmitting positioning information to a network in a wireless communication system, including a radio frequency (RF) unit configured to transmit/receive a radio signal and a processor configured to control the RF unit, wherein the processor controls the RF unit to detect proximity of a cell other than a cell (a serving cell) in which the user equipment stays, acquire position of the user equipment, and transmit positioning information indicating the acquired position to the network.

In each aspect of the present invention, the serving cell may be a cell deployed by a network operator and the cell other than the serving cell may be a cell which is not deployed by the network operator.

In each aspect of the present invention, the cell other than the serving cell may be a closed subscriber group (CSG) cell.

In each aspect of the present invention, the position may be measured while the user equipment enters the proximity of the cell other than the serving cell or while the user equipment leaves the proximity of the cell other than the serving cell.

In each aspect of the present invention, the positioning information may be included in a proximity indication message, used to indicate that the user equipment enters or leaves the proximity of the cell other than the serving cell, to be transmitted to the network.

In each aspect of the present invention, the user equipment may receive a positioning request from the network and transmit the positioning information to the network via a base station of the serving cell as a response to the positioning request.

In each aspect of the present invention, the positioning information may be included in a proximity indication message, used to indicate that the user equipment enters or leaves the proximity of the cell other than the serving cell, to be transmitted to the network via a base station of the serving cell.

It will be appreciated by persons skilled in the art that that the effects that can be achieved through the present invention are not limited to what has been particularly described hereinabove and other advantages of the present invention will be more clearly understood from the following detailed description.

### Advantageous Effects

According to embodiments of the present invention, a network can easily discern coverage of a specific cell.

It will be appreciated by persons skilled in the art that that the effects that can be achieved through the present invention are not limited to what has been particularly described hereinabove and other advantages of the present invention will be more clearly understood from the following detailed description.

### DESCRIPTION OF DRAWINGS

The accompanying drawings, which are included to provide a further understanding of the invention, illustrate embodiments of the invention and together with the description serve to explain the principle of the invention. In the drawings:

FIG. 1 is a view schematically illustrating a network structure of an E-UMTS as an exemplary radio communication system;

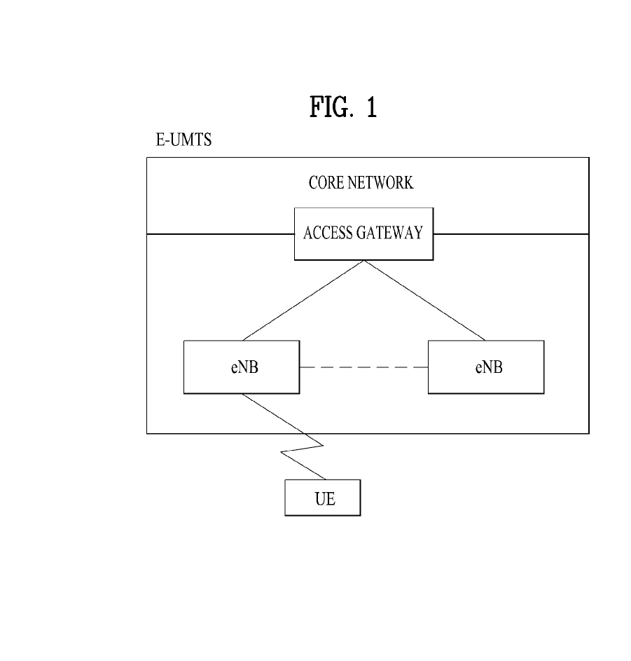

FIG. 2 is a view conceptually illustrating the structure of an evolved universal terrestrial radio access network (E-UTRAN);

FIG. 3 is a view illustrating a control plane and a user plane of a radio interface protocol between a UE and an E-UTRAN based on a 3GPP radio access network specification;

FIG. 4 is a view explaining a general transmission and reception method using a paging message;

FIG. 5 is a view illustrating inbound mobility in which a UE moves to a femto cell from a macro cell according to an embodiment of the present invention;

FIG. 6 is a view illustrating outbound mobility in which a UE moves to a macro cell from a femto cell according to an embodiment of the present invention; and

FIG. 7 is a block diagram illustrating elements of a transmitter 10 and a receiver 20 implementing the present invention.

### BEST MODE

The following embodiments are combinations of elements and features of the present invention in a predetermined manner. Each of the elements or features may be considered selective unless mentioned otherwise. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment.

In the present specification, embodiments of the present invention are described focusing upon a data transmission and reception relationship between an eNB and a UE. Here, the eNB refers to a terminal node of a network communicating directly with the UE. In the present specification, a specific operation described as being performed by the eNB may be performed by an upper node of the eNB. Namely, it is apparent that, in a network comprised of a plurality of network nodes including the eNB, various operations performed for communication with the UE may be performed by the eNB or network nodes other than the eNB. The term ‘eNB’ (eNode B) may be replaced with the terms fixed station, base station (BS), Node B, access point, etc. The term relay may be replaced with the terms relay node (RN), relay station (RS), etc. The term ‘UE’ may be replaced with the terms terminal, mobile station (MS), mobile subscriber station (MSS), subscriber station (SS), etc.

The specific terms used in the following description are provided to aid in understanding of the present invention and may be changed without departing from the spirit of the present invention.

In some instances, known structures and devices are omitted or are shown in block diagram form, focusing on important features of the structures and devices, so as not to obscure the concept of the present invention. The same reference numbers will be used throughout this specification to refer to the same or like parts.

Embodiments of the present invention can be supported by standard documents disclosed in at least one wireless access system of an IEEE 802 system, a 3GPP system, a 3GPP LTE system, an LTE-advanced (LTE-A) system, and a 3GPP2 system. Namely, among the embodiments of the present invention, steps or parts which are not described to clarify the technical features of the present invention can be supported by the above standard documents. In addition, all terms disclosed herein can be supported by the above standard documents.

The following embodiments of the present invention can be applied to a variety of wireless access technologies, for example, code division multiple access (CDMA), frequency division multiple access (FDMA), time division multiple access (TDMA), orthogonal frequency division multiple access (OFDMA), single carrier frequency division multiple access (SC-FDMA), and the like. CDMA may be embodied as radio technology such as universal terrestrial radio access (UTRA) or CDMA2000. TDMA may be embodied as radio technology such as global system for mobile communications (GSM)/general packet radio service (GPRS)/enhanced data rates for GSM evolution (EDGE). OFDMA may be embodied with radio technology such as IEEE 802.11 (Wi-Fi), IEEE 802.16 (WiMAX), IEEE 802-20, and evolved UTRA (E-UTRA). UTRA is a part of a universal mobile telecommunications system (UMTS). 3rd generation partnership project (3GPP) long-term evolution (LTE) is part of an evolved UMTS (E-UMTS), which uses E-UTRA. 3GPP LTE employs OFDMA in downlink and employs SC-FDMA in uplink. LTE-advanced (LTE-A) is an evolved version of 3GPP LTE. WiMAX can be described by the IEEE 802.16e standard (WirelessMAN-OFDMA reference system) and advanced IEEE 802.16m standard (WirelessMAN-OFDMA advanced system). For clarity, the following description focuses on the 3GPP LTE(-A). However, technical features of the present invention are not limited thereto.

In the present invention, a cell refers to a prescribed geographic region to which a communication service is provided by one eNB or one antenna group. In the present invention, communicating with a specific cell may mean communicating with an eNB or an antenna group that provides a communication service to the specific cell. In addition, a downlink/uplink signal of a specific cell may refer to a signal received/transmitted from/to an eNB or an antenna group of the specific cell.

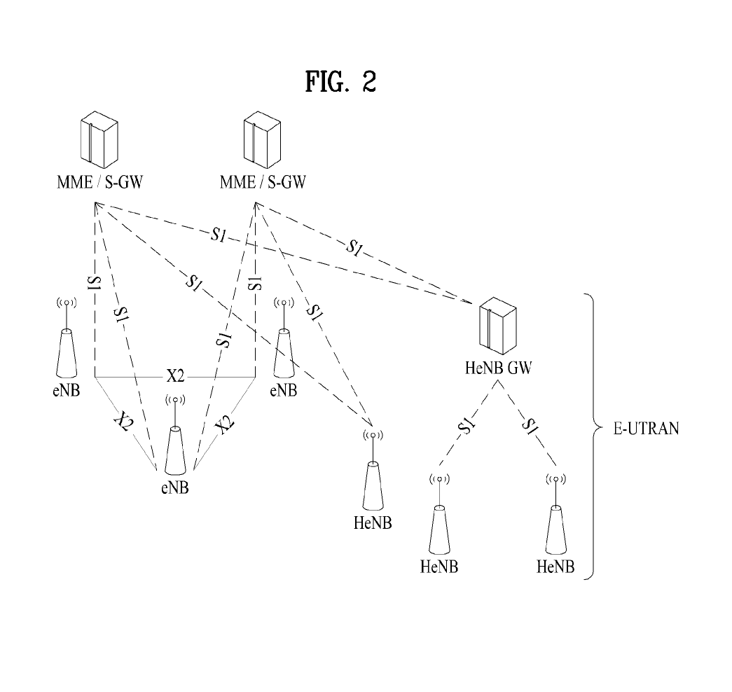

FIG. 2 is a view conceptually illustrating the structure of an evolved universal terrestrial radio access network (E-UTRAN).

A 3GPP LTE system is a mobile communication system that has evolved from a UMTS system. As illustrated in FIG. 2, the 3GPP LTE system architecture can be roughly classified into an evolved UMTS terrestrial radio access network (E-UTRAN) and an evolved packet core (EPC). The E-UTRAN may include a UE and an eNB, wherein the connection between UE and the eNB is referred to as a Uu interface and the connection between the eNBs is referred to as an X2 interface. The EPC includes a mobility management entity (MME) performing a control plane function and a serving gateway (S-GW) performing a user plane function, wherein the connection between the eNB and the MME is referred to as an S1-MME interface, the connection between the eNB and the S-GW is referred to as an S1-U interface, and both connections are commonly referred to as an S1 interface.

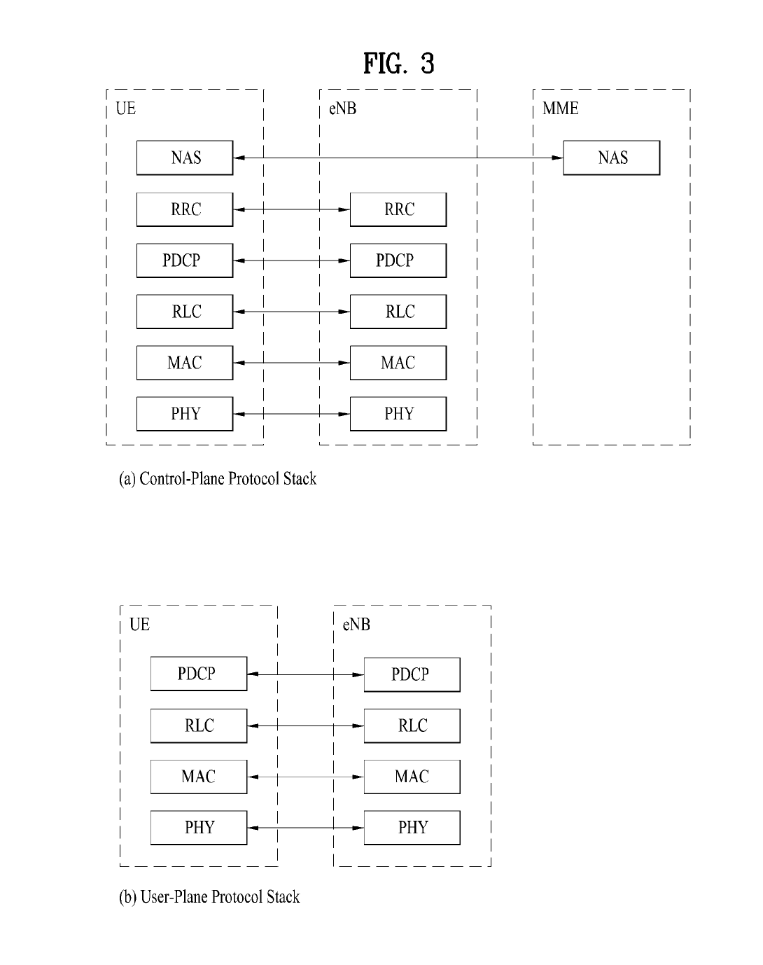

A radio interface protocol is defined in the Uu interface which is a radio section. The radio interface protocol is horizontally comprised of a physical layer, a data link layer, and a network layer and is vertically classified into a user plane for user data transmission and a control plane for signaling (control signal) transmission. The radio interface protocol can be typically divided into L1 (first layer) including a PHY layer which is a physical layer, L2 (second layer) including medium access control (MAC)/radio link control (RLC)/protocol data convergence protocol (PDCP) layers, and L3 (third layer) including a radio resource control (RRC) layer, as illustrated in FIGS. 2 and 3, based on the three lower layers of an open system interconnection (OSI) reference model widely known in the field of communication systems. These layers exist as a pair in the UE and E-UTRAN, thereby performing data transmission of the Uu interface.

The E-UTRAN may include home eNBs (HeNBs) and may deploy an HeNB gateway (GW) for the HeNBs. The HeNBs are connected to the EPC through the HeNB GW or are directly connected to the EPC. The HeNB GW is recognized by the MME as a normal cell and is recognized by the HeNBs as the MME. Accordingly, the HeNB is connected to the HeNB GW through the S1 interface and the HeNB GW is connected to the EPC through the S1 interface. In addition, even in the case that the HeNB is directly connected to the EPC, the HeNB is connected to the EPC through the interface S1.

The HeNB may be installed in an area covered by the macro BS (overlay type) or may be installed in a shadow area that cannot be covered by the macro BS (non-overlay type). Generally, as compared with an eNB owned by a mobile communication network operator, the HeNB has lower radio transmission output. Accordingly, a service coverage provided by the HeNB is generally smaller than a service coverage provided by the eNB. For this reason, the HeNB is referred to as a micro eNB. For example, a pico eNB, a femto eNB, a relay, etc. may be micro eNBs. The micro eNB corresponds to a small-scale version of a macro eNB. Accordingly, the micro eNB may independently operate while performing most of the functions of the macro eNB. As compared to the macro eNB, the micro eNB has a narrower coverage range and lower transmission power and may accommodate a smaller number of UEs. In the present invention, a network in which the macro eNB coexists with the micro eNB even when the same radio access technology (RAT) is used is referred to as a heterogeneous network and a network including only the macro eNB or including only the micro eNBs is referred to as a homogeneous network. For example, each of a pico eNB, a femto eNB, an HeNB, and a relay may be the micro eNB and a geographic region to which a communication service is provided by the micro eNB may be referred to as a micro cell, a pico cell, a femto cell, etc.

FIG. 3 is a view illustrating a control plane and a user plane of a radio interface protocol between a UE and a an E-UTRAN based on a 3GPP radio access network specification.

Referring to FIG. 3, a physical (PHY) layer, which is the first layer, provides an information transfer service to a higher layer using a physical channel. The PHY layer is connected to a medium access control (MAC) layer of the higher layer through a transport channel. Data between the MAC layer and the PHY layer is transferred through the transport channel. At this time, the transport channel is broadly divided into a dedicated transport channel and a common transport channel according to whether or not the channel is shared. In addition, data between different PHY layers, i.e., between the PHY layer of a transmitter side and the PHY layer of a receiver side is transferred through the PHY channel using radio resources.

The second layer includes various layers. First, the MAC layer serves to map various logical channels to various transport channels and also to perform logical channel multiplexing of mapping several logical channels to one transport channel. The MAC layer is connected to a radio link control (RLC) layer of a higher layer through a logical channel. The logical channel is divided into a control channel for transmitting information on a control plane and a traffic channel for transmitting information on a user plane according to the type of information to be transmitted.

The RLC layer of the second layer segments and concatenates data received from a higher layer to appropriately adjust data size such that a lower layer may transmit data to a radio section. In addition, the RLC layer provides three operation modes such as a transparent mode (TM), an un-acknowledged mode (UM), and an acknowledged mode (AM) so as to guarantee various Quality of Service (QoS) required by each radio bearer (RB). In particular, the RLC layer in the AM performs data retransmission through an automatic repeat and request (ARQ) function to reliably transmit data.

A packet data convergence protocol (PDCP) layer of the second layer performs a header compression function for reducing the size of an internet protocol (IP) packet header, wherein the IP packet is relatively large in size and contains unnecessary control information, in order to efficiently transmit an IP packet such as an IPv4 or IPv6 packet in a radio section with relatively narrow bandwidth. Due to this, information only required from a header portion of data is transmitted, thereby serving to increase the transmission efficiency of the radio section. In addition, in the LTE system, the PDCP layer performs a security function, which includes ciphering for preventing non-authorized users from wiretapping data and integrity protection for preventing non-authorized users from manipulating data.

A radio resource control (RRC) layer located at the uppermost portion of the third layer is defined only in the control plane. The RRC layer serves to control logical channels, transport channels, and physical channels in relation to configuration, reconfiguration, and release of radio bearers (RBs). Here, the RB denotes a logical path provided by the first and second layers of a radio protocol to transfer data between the UE and the UTRAN. In general, configuring the RB refers to a procedure for specifying the characteristics of a radio protocol layer and a channel required to provide a specific service and establishing detailed parameters and operation methods of the radio protocol layer and the channel. The RB is divided into a signaling RB (SRB) and a data RB (DRB). The SRB is used as a path for transmitting an RRC message in the control plane and the DRB is used as a path for transmitting user data in the user plane. Each cell serviced by an eNB provides a downlink or uplink transmission service to one or more UEs. Downlink transport channels carrying information from a network to a UE include a broadcast channel (BCH) transmitting system information, a paging channel (PCH) transmitting paging messages, and a downlink shared channel (SCH) transmitting user traffic or control messages. Traffic or control messages of a downlink multicast or broadcast service may be transmitted via the downlink SCH or an additional downlink multicast channel (MCH). Meanwhile, uplink transport channels carrying information from the UE to the network include a random access channel (RACH) transmitting an initial control message and an uplink SCH transmitting user traffic or control messages. Logical channels, which are located above the transport channels and mapped to the transport channels, include a broadcast control channel (BCCH), a paging control channel (PCCH), a common control channel (CCCH), a multicast control channel (MCCH), and a multicast traffic channel (MTCH).

A non-access stratum (NAS) layer is defined only in the control plane of the UE and the MME. NAS control protocol is terminated in the MME on the network side and perform functions such as an evolved packet system (EPS) bearer management, authentication, EPS connection management (ECM)-idle state (ECM-IDLE) mobility handling, call origination in ECM-IDLE, and security control. To manage mobility of the UE in the NAS layer, two states are defined, i.e. an EPS mobility management (EMM)-registered state (EMM-REGISTERED) and an EMM-deregistered state (EMM-DEREGISTERED). These two states are applied to the UE and the MME. Initially, the UE is in the EMM-DEREGISTERED state. To access the network, the UE performs a process of registering to the network through an initial attach procedure. If the attach procedure is successfully performed, the UE and the MME enter the EMM-REGISTERED state.

Meanwhile, to manage a signaling connection between the UE and the EPC, an ECM-idle (ECM-IDLE) state and an ECM-connected (ECM-CONNECTED) state are defined. These two states are applied to the UE and the MME. When the UE in the ECM-IDLE state establishes an RRC connection with the E-UTRAN, the UE enters the ECM-CONNECTED state. When the MME in the ECM-IDLE state establishes an RRC connection with the E-UTRAN, the MME enters the ECM-CONNECTED state. When the UE is in the ECM-IDLE state, the E-UTRAN does not contain context information of the UE. Therefore, the UE in the ECM-IDLE state performs a UE-based mobility related procedure such as cell selection or reselection without receiving a command of the network. On the other hand, when the UE is in the ECM-CONNECTED state, mobility of the UE is managed by the command of the network. If a location of the UE in the ECM-IDLE state becomes different from a location known to the network, the UE reports the location thereof to the network through a tracking area (TA) update procedure.

Hereinafter, an RRC state and RRC connection method of the UE will be described. The RRC state refers to whether or not the RRC layer of the UE is logically connected to the RRC layer of the E-UTRAN. If connected, then it is called an RRC_CONNECTED state and, otherwise, it is called an RRC_IDLE state.

Specially, when the UE is initially turned on by a user, the UE first searches for a suitable cell and then camps in the suitable cell in an RRC_IDLE state. The E-UTRAN cannot recognize the UE in the RRC_IDLE state in a cell unit, and therefore, a core network (CN) manages the UE in a tracking area (TA) unit, which is a unit larger than a cell. The UE in the RRC_IDLE state may receive broadcast system information and paging information while performing discontinuous reception (DRX) configured by the NAS and may be assigned a UE-specific identity. In addition, the UE in the RRC_IDLE state may perform selection and reselection of a public land mobile network (PLMN).

To receive services such as voice or data from the cell, the UE in the RRC_IDLE state should perform transition to an RRC_CONNECTED state. The UE in the RRC_IDLE state establishes an RRC connection with RRC of the E-UTRAN through an RRC connection establishment procedure only when it is required to make an RRC connection, thereby changing the state to the RRC_CONNECTED state. There are several cases when the UE in the RRC_IDLE state is required to make an RRC connection. For example, uplink data transmission is required due to a phone call attempt by the user or transmission of a response message is required in response to a paging message received from the E-UTRAN.

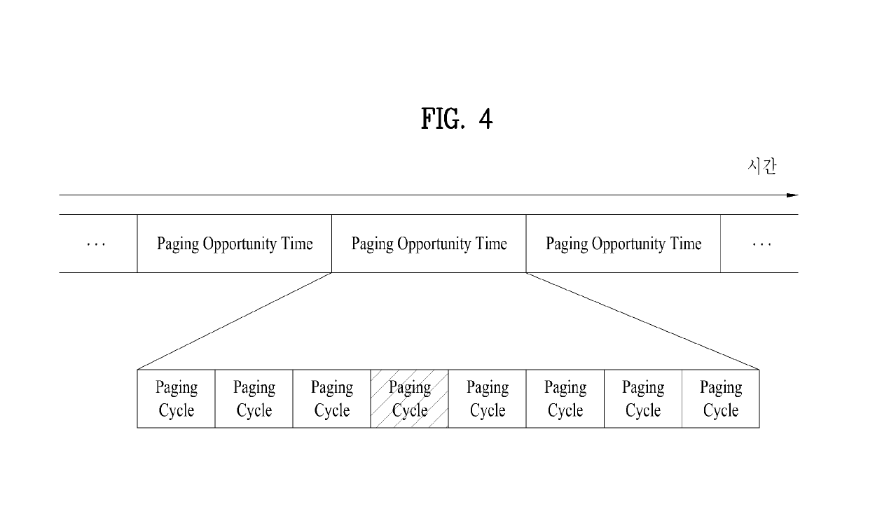

FIG. 4 is a view explaining a general transmission and reception method using a paging message.

Referring to FIG. 4, the paging message includes a paging record comprised of a paging cause and a UE identity. Upon receiving the paging message, the UE may perform a DRX operation in order to reduce power consumption.

Specifically, a network configures a plurality of paging occasions (POs) in every time cycle called a paging DRX cycle and a specific UE receives only a specific PO to acquire the paging message. The UE may not receive a paging channel in POs other than the specific PO and may be in a sleep state in order to reduce power consumption. One PO corresponds to one transmission time interval (TTI).

The eNB and the UE use a paging indicator (PI) as a specific value indicating transmission of the paging message. The eNB may define a specific identity (e.g. paging-radio network temporary identity (P-RNTI)) as the PI and inform the UE of paging information transmission. For example, the UE wakes up in every DRX cycle and receives one subframe to determine the presence of a paging message directed thereto. In the presence of the P-RNTI on an L1/L2 control channel (a PDCCH) in the received subframe, the UE is aware that a paging message exists on a PDSCH of the subframe. When the paging message includes an identity of the UE (e.g. an international mobile subscriber identity (IMSI)), the UE receives a service by responding to the eNB (e.g. establishing an RRC connection or receiving system information).

Meanwhile, system information includes essential information necessary to connect a UE to an eNB. Accordingly, the UE should receive all system information before being connected to the eNB and should always have up-to-date system information. The eNB periodically transmits the system information because all UEs located in a cell should know the system information. The system information may be divided into a master information block (MIB), a scheduling block (SB), and a system information block (SIB). The MIB enables a UE to become aware of a physical configuration of a cell (e.g. bandwidth). The SB indicates transmission information of SIBs, for example, a transmission period. The SIB is a set of associated system information. For example, a specific SIB includes only information about peripheral cells and another SIB includes only information about an uplink channel used by the UE.

To inform the UE as to whether system information has been changed, the eNB transmits a paging message. The paging message includes a system information change indicator. The UE receives the paging message in a paging cycle. If the paging message includes the system information change indicator, the UE receives the system information through a BCCH of a logical channel.

Meanwhile, the E-UTRAN can recognize the presence of the UE in an RRC_CONNECTED state in the cell unit and, thus, the E-UTRAN can effectively control the UE. Accordingly, the network may transmit data to the UE in the RRC_CONNECTED state and receive data from the UE. In the RRC_CONNECTED state, the network controls mobility of the UE. That is, the network determines to which E-UTRA cell(s) or inter-RAT cell the UE should be connected. The network triggers a handover procedure based on radio conditions, load, etc. To this end, the network may configure the UE to perform a measurement report (including configuration of a measurement gap). The network may initiate handover without receiving the measurement report from the UE.

Before transmitting a handover message to the UE, an eNB (hereinafter, a source eNB) of a cell to which the UE is currently connected transmits all necessary information to an eNB (hereinafter, a target eNB) of a cell (hereinafter, a target cell) to which the UE is handed over. If carrier aggregation is configured, which uses wider uplink/downlink bandwidth by aggregating a plurality of uplink/downlink frequency blocks, the source eNB may provide a list of component carriers (CCs) having best radio quality and may selectively provide measurement results of the CCs so that the target eNB may select a secondary CC (also called an SCell). The target eNB may generate a message used to perform handover, i.e. a handover message including an access stratum (AS) configuration to be used in the target cell(s). The source eNB transparently forwards the handover message received from the target eNB to the UE without modifying values/content in the handover message. When appropriate, the source eNB may initiate data forwarding for DRBs. After receiving the handover message, the UE attempts to access a carrier of the target cell (e.g. a carrier (also called a primary CC (PCC or PCell)) operating on a primary carrier frequency) through a random access procedure. Upon successful completion of the handover, the UE sends a message used to confirm handover. In the event of handover failure, the source eNB and the UE keep some context (e.g. cell (C)-RNTI) for some time to enable return of the UE to a cell of the source eNB. If the random access procedure towards the target cell is not successful within a certain time, i.e. if failure of handover to the target cell is detected, the UE attempts to re-establish an RRC connection with the source eNB or attempts to establish the RRC connection in another cell using an RRC connection reconfiguration procedure.

Meanwhile, a HeNB may be configured to provide services only to a closed subscriber group (CSG). In this case, a cell of the HeNB providing services only to the CSG is referred to as a CSG cell. The CSG cell may be a femto cell which broadcasts a CSG indicator, set to TRUE, and a specific CSG identity (ID). Each CSG cell has its own identity which is called a CSG ID. The UE may have a list of CSG cells (hereinafter, a CSG whitelist) to which the UE belongs as a member of the CSG cells. The CSG whitelist may be changed at the request of the UE or the command of the network. Generally, one HeNB may support one CSG cell. The HeNB transmits a CSG ID of a CSG cell supported by the HeNB through system information and permits only the UE, which is a member of the CSG, to access to the HeNB. The HeNB does not always have to permit access only to the CSG UE. According to configuration of the HeNB, access to a UE other than the CSG UE may be permitted. For example, a hybrid cell, which is accessible as a CSG cell by the CSG UE and accessible as a normal cell by other UEs, may be configured. Determination to which UE access is permitted may be changed depending on configuration of an operation mode of the HeNB.

The UE in the RRC_IDLE state performs cell selection/reselection upon a CSG cell(s) according to an autonomous search function. Mobility of the UE to the CSG is referred to as inbound mobility to the CSG cell. The search function determines when and where to search for the CSG cell and does not need the help of the network regarding information about frequencies used only for the CSG cells. To aid in the search function on mixed carriers, all CSG cells on the mixed carriers broadcast physical cell identifier (PCI) values, which are reserved by the network for use thereby, as system information. Optionally, even non-CSG cells on the mixed carriers may transmit such information as the system information. The range of the reserved PCI values is applicable only to a frequency of a PLMN in which the UE receives such information. The UE may regard the received PCI values for the CSG cells to be effective for a maximum of 24 hours in the entire PLMN. Use of the UE of the received PCI information depends on implementation of the UE. The UE checks suitability of CSG cells identified by a CSG indicator based on a CSG whitelist in the UE, provided by a higher layer. Upon detecting a CSG cell, the UE may confirm which CSG the CSG cell supports by reading a CSG ID included in the system information. The UE, which has read the CSG ID, regards the corresponding cell to be an accessible cell only when the UE is a member of the CSG cell, i.e. when the CSG ID indicates a CSG cell belonging to the CSG whitelist of the UE. If the CSG whitelist configured by the UE is empty, autonomous search for CSG cells by the UE is disabled by the search function. In addition to the autonomous search for the CSG cells, manual selection of the CSG cells is supported. Cell selection/reselection for the CSG cells does not need for the network to provide information about neighboring cells to the UE. In a few special cases, for example, if the network desires to trigger the UE to search for the CSG cells, the network may provide the information about neighboring cells to the UE.

Inbound mobility to the CSG cell for the UE in the RRC_CONNECTED state may be performed. The UE in the RRC_CONNECTED state performs a normal measurement procedure and mobility procedure based on configuration provided by the network. That is, the normal measurement procedure and mobility procedure may be used to support handover to cells broadcasting CSG IDs. The UE in the RRC_CONNECTED state does not need to support manual selection of the CSG IDs. Handover to the HeNB such as the CSG cell is different from a normal handover procedure in the following three aspects.

(1) Proximity estimation: In case in which the UE is able to determine that the UE is near a CSG cell or hybrid cell, a CSG ID of which is in the CSG whitelist of the UE, using the autonomous search function, the UE may provide a proximity indication to a source eNB. The proximity indication may be used as follows.
If a measurement configuration for a concerned frequency/RAT is not present, the source eNB may configure the UE to perform measurement and reporting for the concerned frequency/RAT. Specifically, the source eNB may configure the UE to report entering or leaving the proximity of a cell(s) included in a CSG cell whitelist of the UE. Further, the source eNB may request that the UE provide additional information (e.g. a cell global ID, a CSG ID, or a CSG membership status) broadcast by a handover candidate cell. For reference, the source eNB may use a proximity indication procedure in order to configure measurement as well as to determine whether to request the additional information broadcast by the handover candidate cell. The additional information is used to verify whether the UE has authority to access a target carrier. The additional information may be needed to identify a corresponding handover candidate cell when a physical layer ID included in the measurement report cannot identify the cell.
The source eNB may determine whether to perform other actions related to handover to the HeNB based on the received proximity indication. For example, the source eNB may not configure the UE to acquire system information of the HeNB unless the source eNB has received the proximity indication.

(2) Packet scheduling cell (PSC)/physical cell identifier (PCI) confusion: Due to the typical cell size of a HeNB being much smaller than that of a macro cell, multiple HeNBs having the same PSC/PCI may be present within the coverage of the source eNB. In this case, the source eNB is unable to determine a correct target cell for handover from the PSC/PCI included in the measurement report. This is called PSC/PCI confusion. PSC/PCI confusion is solved by the UE reporting the global cell ID to a target HeNB.

(3) Access control: If a target cell is a hybrid cell, priority of allocated resources may be determined based on the membership status of the UE. Access control is performed by a first process in which the UE determines the membership status based on a CSG ID received from the target cell and on the CSG whitelist of the UE and by a second process in which the network verifies a reported status.

In relation to the proximity indication procedure, if a femto cell which is not deployed by the operator is near to a cell deployed by the operator (hereinafter, a non-femto cell), the femto cell may create interference with respect to the non-femto cell. However, since femto cells are not deployed by the operator, the operator cannot be aware how the femto cells are deployed.

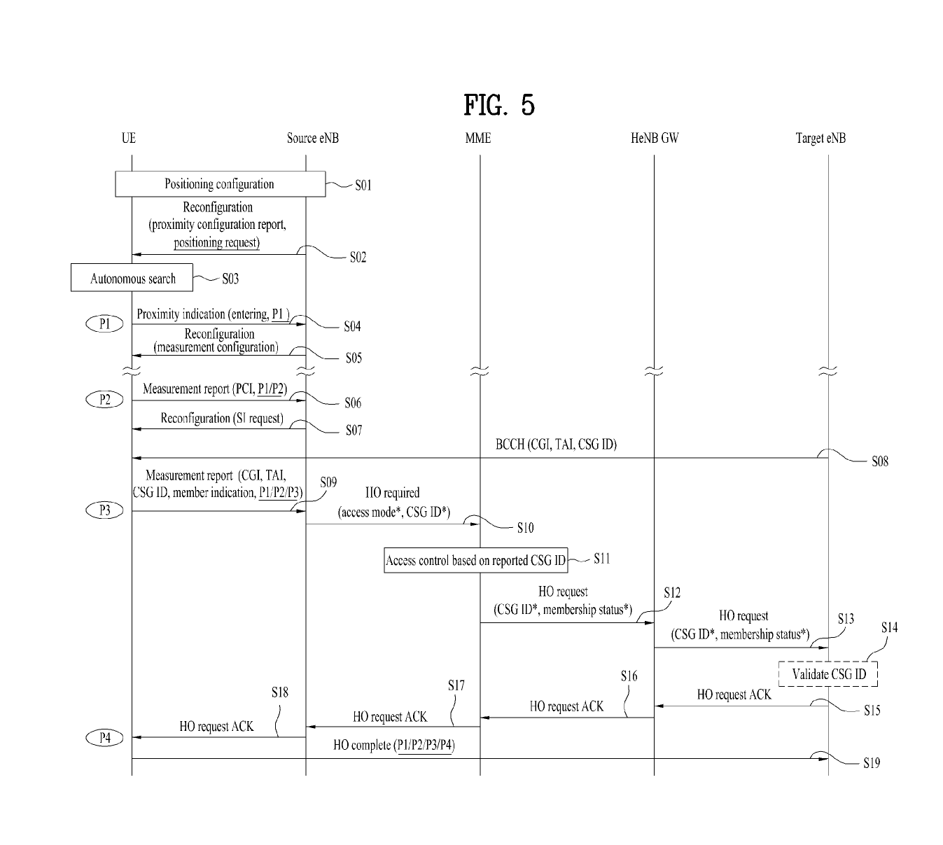

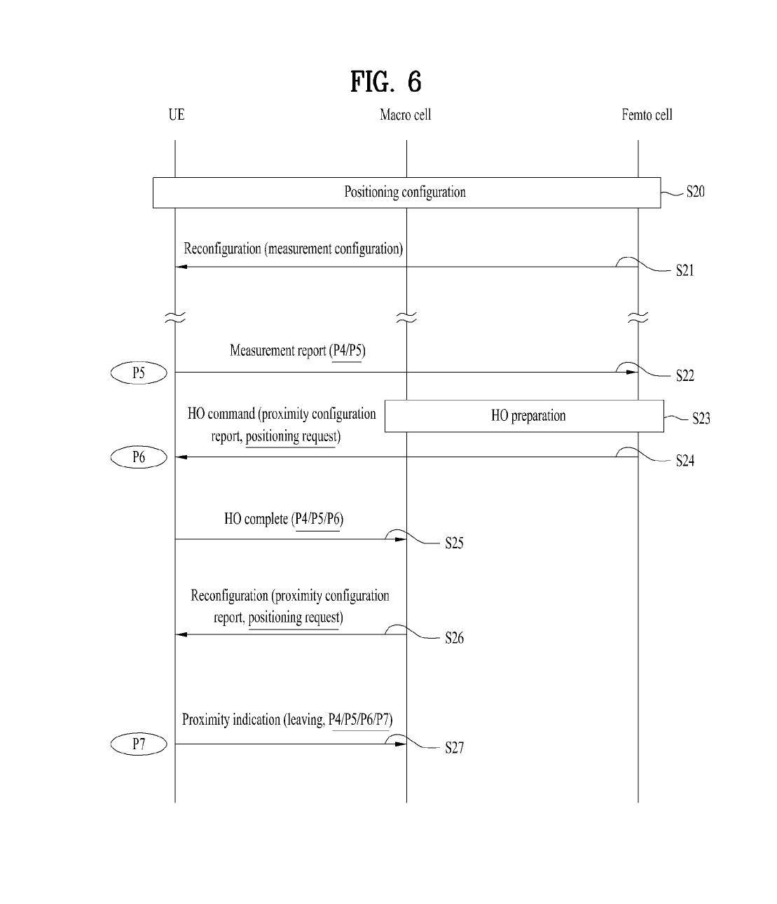

Accordingly, to provide information about coverage of the femto cell to the operator, the present invention proposes an embodiment in which, if a UE enters the proximity of a neighboring cell, information indicating the location of the proximity of the neighboring cell is reported to a serving cell in which the UE stays. The UE may determine a femto/CSG cell, a CSG ID of which is stored in the UE, to be the neighboring cell. The location may be included in a proximity indication or measurement report to be reported to the serving cell. The proximity indication may include information indicating a carrier frequency of the neighboring cell. The proximity indication may also include information indicating that the UE enters the proximity of the neighboring cell. The measurement report may include measurement results (e.g. signal strength, reference signal received power (RSRP), reference signal received quality (RSRQ), path loss, etc.) of the neighboring cell. The present invention also proposes an embodiment in which, when the UE leaves the proximity of the neighboring cell, the UE reports information about the location of the proximity of the neighboring cell to the serving cell. The embodiments of the present invention will be described hereinbelow with reference to FIG. 5 and FIG. 6. For convenience of description, the embodiment of the present invention will be described by referring to each of a CSG cell, a femto cell, and a hybrid cell as a femto cell.

FIG. 5 is a view illustrating inbound mobility in which a UE moves to a femto cell from a macro cell according to an embodiment of the present invention. In describing FIG. 5, an eNB of the macro cell is referred to as a source eNB and an eNB of the femto cell is referred to as a target HeNB.

Referring to FIG. 5, a UE, which has received a request for reporting of positioning information and a proximity configuration from a source eNB, may report positioning information, regarding the proximity/coverage of a femto cell of a target HeNB having a CSG ID in a CSG whitelist of the UE to a network. The UE performing inbound mobility may measure at least one of the following four positions and report positioning information indicating at least one of the measured positions to the network:
P1: position of the UE when the femto cell is detected through autonomous search or when a proximity indication for a carrier frequency of the femto cell is constructed for entry to the femto cell,
P2: position of the UE when the UE measures the femto cell or when the UE constructs a measurement report with a PCI of the femto cell,
P3: position of the UE when the UE reads system information of the femto cell or when the UE constructs the measurement report for the femto cell after reading the system information, and
P4: position of the UE when the UE receives a command regarding handover (HO) to the femto cell, when the UE performs a random access procedure for handover or when the UE constructs an HO complete message to be transmitted to the femto cell.

The UE may acquire the above positions using a configured positioning method or a global positioning system (GPS) receiver thereof.

In more detail, referring to FIG. 5, according to the present invention, the UE may configure a positioning method (e.g. an observed time difference of arrival (OTDOA)) (S01). The UE may use the GPS receiver thereof. A source eNB may control the UE to configure the positioning method.

The source eNB may request that the UE report a proximity configuration using proximity indication control (S02). For example, the source eNB may transmit an RRC connection reconfiguration message including a proximity configuration report (reportProximityConfig) to the UE. The source eNB may include a positioning request (PositioningRequest) in the RRC connection reconfiguration message for requesting reporting of the proximity configuration and the RRC connection reconfiguration message including the positioning request to the UE (S02). Alternatively, the source eNB may transmit a positioning configuration message to the UE through LTE positioning protocol (LPP) to cause the UE to configure the positioning method. The UE performs a proximity indication according to the request of the proximity configuration report and performs positioning according to the positioning request. In other words, if the UE determines that a CSG ID may be in the proximity of a cell in a CSG whitelist thereof based on an autonomous search procedure (S03), i.e. if it is detected that the UE is in the proximity of the femto cell, the UE may transmit P1 to the source eNB together with or separately from an “entering” proximity indication message (S04). The “entering” proximity indication and/or P1 may be included in an RRC connection reconfiguration complete message and transmitted from the UE to the source eNB, when the search procedure and/or positioning procedure for the proximity indication is ended. The UE in an RRC_CONNECTED state may initiate transmission of the proximity indication in the following cases.

1> if the UE enters the proximity of one or more cells, whose a CSG ID(s) is/are in the CSG whitelist of the UE, on an E-UTRA frequency while proximity indication is enabled for such E-UTRA cell(s); or

1> if the UE enters the proximity of one or more cells, whose a CSG ID(s) is/are in the CSG whitelist of the UE, on a UTRA frequency while proximity indication is enabled for such UTRA cell(s):

2> if the UE has previously not transmitted a proximity indication for the RAT and frequency during a current RRC connection, or if more than five seconds have elapsed since the UE has lastly transmitted a proximity indication (of entering or leaving) for the RAT and frequency:

3> Transmission of the proximity indication may be initiated.

Under the above conditions, “if the UE enters the proximity of one or more cells, whose CSG ID(s) is/are in the CSG whitelist of the UE” includes the case in which the UE has already been in the proximity of such a cell(s) when a proximity indication for a corresponding RAT is enabled.

To transmit a proximity indication message used to indicate that the UE enters or leaves the proximity of a member femto cell(s), the UE may configure the contents of the proximity indication message as follows.

1> if the UE applies a procedure for reporting that the UE enters the proximity of a cell(s) whose CSG ID(s) is/are in the CSG whitelist of the UE,

2> set type to “entering”;

1> if the proximity indication was triggered for one or more cells, whose CSG ID(s) is/are in the CSG whitelist of the UE, on an E-UTRA frequency:

2> set a carrier frequency to ‘eutra’ with a value set to an evolved absolute radio frequency channel number (E-ARFCN) value of an E-UTRA cell(s) for which proximity indication was triggered;

1> if the proximity indication was triggered for one or more cells, whose CSG ID is/are in the CSG whitelist of the UE, on a UTRA frequency:

2> set a carrier frequency to ‘utra’ with a value set to an ARFCN value of a UTRA cell(s) for which proximity indication was triggered.

Meanwhile, if a measurement configuration is not present for a concerned frequency/RAT, the source eNB configures the UE with a relevant measurement configuration including necessary measurement gaps so that the UE may perform measurement in a reported RAT and frequency (S05). If the UE is not within a geographic region in which a cell whose CSG ID is in a CSG whitelist of the UE, is located, a network may use the proximity indication to minimize the request of the HO preparation information by avoiding request of HO preparation information of the femto cell. Upon receiving the measurement configuration from the source eNB, the UE may transmit P2 to the source eNB together with or separately from a measurement report including a PCI (S06). If the UE has never transmitted P1 to the source eNB or even if the UE has transmitted P1, the UE may transmit P1 as well as P2 to the source eNB. The measurement report may be constructed when a channel state of a neighboring cell becomes better than a channel state of a PCell of a serving cell by a predetermined offset.

Meanwhile, the source eNB may configure the UE to perform system information (SI) acquisition and reporting of a particular PCI (S07). Upon receiving the SI acquisition request from the source eNB, the UE may perform SI acquisition from a target HeNB using autonomous gaps (S08). That is, the UE may suspend reception and transmission with the source eNB within the prescribed constraints to acquire the relevant SI from the target HeNB. The SI transmitted by the target HeNB may include an E-UTRA cell global identifier ((E-)CGI), and a tracking area identity (TAI) and may be transmitted to the UE from the target HeNB through a BCCH. Upon acquiring the SI of the target HeNB, the UE may transmit a measurement report including an (E-)CGI, a TAI, a CSG ID, and a member/non-member indication to the source eNB (S09). The measurement report may include P3. If the UE has transmitted P1 to the source eNB in steps S04 and S06 or if the UE has transmitted P1; the UE may include P1 in the measurement report to transmit to the source eNB. In step S06, if the UE has not transmitted P2 to the source eNB or even if has transmitted P2, the UE may include P2 in the measurement report to transmit to the source eNB.

The source eNB may transmit an HO required message including the (E-)CGI and CSG ID of the target cell to an MME (S 10). If the target cell is a hybrid cell, cell access mode may also be included in the HO required message. The MME performs UE access control to a corresponding femto cell, based on the CSG ID received in the HO required message and CSG subscription data stored for the UE (S11). If the UE access control procedure fails, the MME ends the HO procedure by transmitting an HO preparation failure message as a response to the HO access control procedure. If there is a cell access mode, the MME determines a CSG membership status of the UE for the hybrid cell and includes the CSG membership status in an HO request message. The MME may send the HO request message including the target CSG ID received in the HO required message to the target HeNB (S12 and S13). If the target cell is a hybrid cell, the CSG membership status will be included in the HO request message. The HO request message may be transmitted from the MME to the target HeNB (S13) via a HeNB GW (S12).

The target HeNB verifies whether the CSG ID received in the HO request message matches the CSG ID broadcast in the target cell and, if such verification is successful, the target HeNB allocates appropriate resources (S14). UE prioritization may also be applied if the CSG membership status indicates that the UE is a member.

The target HeNB may send an HO request acknowledgement (ACK) to the MME (via the HeNB GW if the HeNB is present) (S15 and S16). Upon receiving the HO request ACK, the MME sends an HO command message to the source eNB (S17). The source eNB may transmit the 1-10 command message, which is an RRC connection reconfiguration message, including mobility control information to the UE (S18). Upon receiving the RRC connection reconfiguration message including the HO command message, the UE completes an HO procedure by transmitting an HO complete message to the target HeNB. The UE may include the positions P1, P2, P3, and/or P4 in the HO complete message to transmit to the target HeNB. If the HO procedure is completed, the femto cell, which was a target cell before the HO procedure is completed, becomes a serving cell.

The above steps S02 to S11 and S17 to S19 may also be applied to inter-RAT moving from an LTE system to the HeNB.

As illustrated in FIG. 5, if the CSG ID of the femto cell is in the whitelist of the UE, the UE may include the positioning information in one of the following messages to report the positioning information to the network.
Proximity indication for the femto cell (S04): only P1 among positions P1, P2, P3, and P4 of the UE may be included in this message to be transmitted to the non-femto cell.
Measurement report having a PCI of the femto cell (S06): only P1 and/or P2 among the positions P1, P2, P3, and P4 of the UE may be included in this message to be transmitted to the non-femto cell.
Measurement report for the femto cell after reading SI (S09): only P1, P2, and/or P3 among the positions P1, P2, P3, and P4 of the UE may be included in this message to be transmitted to the non-femto cell.
HO complete message transmitted to the femto cell (S19): only P1, P2, P3, and/or P4 among the positions P1, P2, P3, and P4 of the UE may be included in this message to be transmitted to the non-femto cell.

If the non-femto cell or femto cell receives the positioning information, the cell informs an open mobile alliance (OMA) or a CN node of the received positioning information and information (e.g. a PCI, CSG ID, CGI, or TAI) about the femto cell and the non-femto cell.

The non-femto cell of the source eNB may configure an almost blank subframe (ABS) so that the UE may measure the non-femto cell or the femto cell. The ABS refers to a subframe which is configured to contain only a specific downlink signal, for example, only a cell-specific reference (CSR) signal or contain a downlink signal at very weak transmit power. Accordingly, a subframe(s) configured as the ABS and the other subframe(s) not configured as the ABS among subframes in a radio frame have different interference levels. Among cells interfering with each other, if an interfering cell configures a prescribed subframe(s) as the ABS, an interfered cell subject to interference by the interfering cell schedules data transmission to the UE in the ABS, thereby mitigating or eliminating interference. If the source eNB configures the ABS in the non-femto cell, the UE may indicate whether an ABS configuration is used through the proximity indication message, the measurement report message, and/or the HO complete message, together with the positioning information.

The present invention may also be applied to outbound mobility in which the UE leaves the femto cell. FIG. 6 is a view illustrating outbound mobility in which a UE moves to a macro cell from a femto cell according to an embodiment of the present invention. In describing FIG. 6, an eNB of a macro cell is referred to as a source eNB and an eNB of a femto cell is referred to as a HeNB.

Referring to FIG. 6, a UE, which has received a request for positioning information and for reporting of a proximity configuration through an HO command or RRC connection reconfiguration message, may report positioning information regarding the proximity/coverage of a femto cell having a CSG ID in the CSG whitelist of the UE to a network. The UE performing outbound mobility may acquire at least one of the following three positions P5 to P7 and report positioning information indicating at least one of P5 to P7 of FIG. 5 to the network:
P5: position of the UE when the UE measures a target non-femto cell, for example, a macro cell or when a measurement event for deciding HO to the non-femto cell occurs,
P6: position of the UE when the UE receives an HO command to the non-femto cell or when the UE constructs an HO complete message to be transmitted to the non-femto cell, and
P7: position of the UE when it is detected that the UE leaves the proximity of the femto cell or when a proximity indication for a carrier frequency of the femto cell is constructed in order to leave the femto cell.

The UE may acquire the above positions using a configured positioning method or a GPS receiver thereof.

In more detail, referring to FIG. 6, according to the present invention, the UE, a HeNB of the femto cell, and/or an eNB of the macro cell may perform a positioning configuration (S20). If a measurement configuration is not present in a concerned frequency/RAT, the HeNB may configure the UE with a relevant measurement configuration including necessary measurement gaps so that the UE may perform measurement in a reported RAT and frequency (S21). Upon receiving the measurement configuration from the HeNB, the UE may transmit a measurement report including a PCI to the HeNB (S22). The UE may include P4 and/or P5 in the measurement report to transmit to the HeNB. If a channel state of the macro cell is better than a channel state of the femto cell to which the UE is currently connected, the HeNB of the femto cell and the eNB of the macro cell prepare HO (S23).

For UE mobility leaving the femto cell in active mode, a normal HO procedure controlled by the network may be applied. The HeNB, which has prepared HO, may transmit an HO command message to the UE (S24). The HeNB may include a proximity configuration report and/or a positioning request to transmit to the UE. If the UE, which has received the HO command message, successfully performs HO to the macro cell, the UE transmits an HO complete message to the eNB of the macro cell (S25). Upon receiving the positioning request, the UE may include P4, P5, and/or P6 in the HO complete message to transmit to the macro cell.

Instead of transmitting the proximity configuration report and positioning request by the femto cell to the UE or even if the femto call transmits the proximity configuration report and positioning request to the UE, the eNB of the macro cell may transmit a message including the proximity configuration report and/or positioning request to the UE (S26). The UE performs a proximity indication according to the request of the proximity configuration report and performs positioning according to the positioning request. If a detection procedure for the proximity indication and/or a positioning procedure are completed, the UE may transmit a message including proximity indication information and/or positioning information to the eNB of the macro cell (S27). The positioning information may include P4, P5, P6, and/or P7.

The UE in the RRC_SONNECTED state may initiate transmission of the proximity indication in the following cases.

1> if the UE leaves the proximity of one or more cells, whose CSG ID(s) is/are in the CSG whitelist of the UE, on an E-UTRA frequency while proximity indication is enabled for such E-UTRA cell(s); or

1> if the UE leaves the proximity of one or more cells, whose CSG ID(s) is/are in the CSG whitelist of the UE, on a UTRA frequency while proximity indication enabled for such UTRA cell(s):

2> if the UE has previously not transmitted a proximity indication for the RAT and frequency during a current RRC connection or if more than five seconds have elapsed since the UE has lastly transmitted a proximity indication (of entering or leaving) for the RAT and frequency:

3> Transmission of the proximity indication may be initiated.

In the above conditions, “if the UE leaves the proximity of one or more cells, whose CSG ID is/are in the CSG whitelist of the UE” includes the case in which the UE has already been in the proximity of such a cell(s) at a time when the proximity indication for a corresponding RAT is enabled.

To transmit a proximity indication message used to indicate that the UE enters or leaves the proximity of a member femto cell(s), the UE may configure content of the proximity indication message as follows.

1> if the UE applies a procedure for reporting that the UE leaves the proximity of a cell(s) whose CSG ID(s) is/are in the CSG whitelist of the UE,

2> set type to “leaving”;

1> if the proximity indication was triggered for one or more cells, whose CSG ID(s) is/are in the CSG whitelist of the UE, on an E-UTRA frequency:

2> set a carrier frequency to ‘eutra’ with a value set to an E-ARFCN value of an E-UTRA cell(s) for which the proximity indication was triggered;

1> if the proximity indication was triggered for one or more cells, whose CSG ID(s) is/are in the CSG whitelist of the UE, on a UTRA frequency:

2> set a carrier frequency to ‘utra’ with a value set to an ARFCN value of a UTRA cell(s) for which the proximity indication was triggered.

As illustrated in FIG. 6, if the CSG ID of the femto cell is in the whitelist of the UE, the UE may include the positioning information in one of the following messages to report to the network.
Measurement report for a target non-femto cell for HO determination (S22): Only P4 and/or P5 among positions P4, P5, P6, and P7 of the UE may be included to be transmitted to the femto cell.
HO complete message transmitted to the non-femto cell (S25): Only P4, P5, and/or P6 among the positions P4, P5, P6, and P7 of the UE may be included in this message to be transmitted to the non-femto cell.
Proximity indication about leaving the femto cell (S27): Only P4, P5, P6, and/or P7 among the positions P4, P5, P6, and P7 of the UE may be included in this message to be transmitted to the non-femto cell.

If the non-femto cell or femto cell receives the positioning information, the cell informs an OMA or a CN node of the received positioning information and information (e.g. a PCI, CSG ID, CGI, or TAI) about the femto cell and the non-femto cell.

The non-femto cell of the source eNB may configure an ABS so that the UE may measure the non-femto cell or the femto cell. In this case, the UE may indicate whether an ABS configuration is used through the proximity indication message, the measurement report message, and/or the HO complete message, together with the positioning information.

The embodiment of FIG. 5 and the embodiment of FIG. 6 may be applied separately or together.

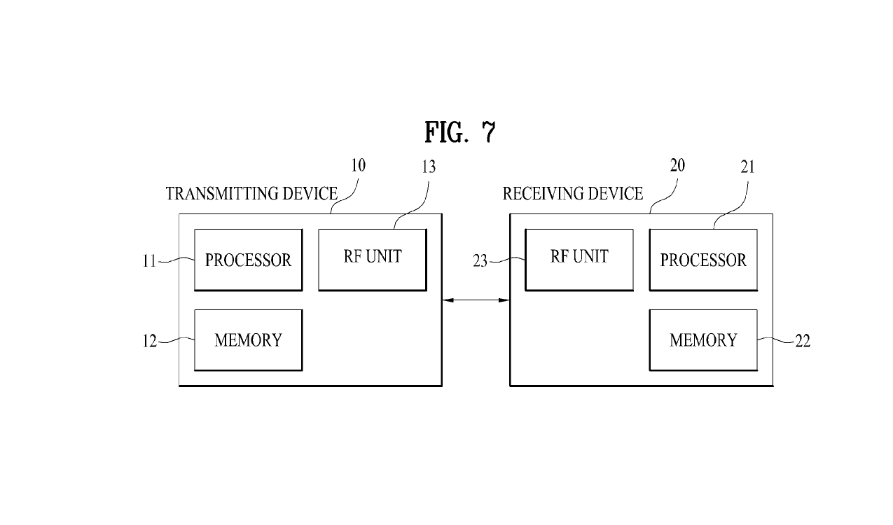

FIG. 7 is a block diagram illustrating elements of a transmitter 10 and a receiver 20 implementing the present invention.

The transmitting device 10 and the receiving device 20 respectively include Radio Frequency (RF) units 13 and 23 capable of transmitting and receiving radio signals carrying information, data, signals, and/or messages, memories 12 and 22 for storing information related to communication in a wireless communication system, and processors 11 and 21 operatively connected to elements such as the RF units 13 and 23 and the memories 12 and 22 to control the elements and configured to control the memories 12 and 22 and/or the RF units 13 and 23 so as to perform at least one of the above-described embodiments of the present invention.

The memories 12 and 22 may store programs for processing and controlling the processors 11 and 21 and may temporarily store input/output information. The memories 12 and 22 may be used as buffers.

The processors 11 and 21 typically control the overall operation of various modules in the transmitting device or the receiving device. The processors 11 and 21 may perform various control functions to perform the present invention. The processors 11 and 21 may be referred to as controllers, microcontrollers, microprocessors, or microcomputers. The processors 11 and 21 may be implemented by hardware, firmware, software, or a combination thereof. In a hardware configuration, application specific integrated circuits (ASICs), digital signal processors (DSPs), digital signal processing devices (DSPDs), programmable logic devices (PLDs), or field programmable gate arrays (FPGAs) may be included in the processors 11 and 21. If the present invention is implemented using firmware or software, firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 codes and modulates signals and/or data which is/are scheduled to be transmitted to the exterior by the processor 11 or a scheduler connected to the processor 11. The coded and modulated signals and/or data are transmitted to the RF unit 13. For example, the processor 11 converts a data stream to be transmitted into K layers through demultiplexing, channel coding, scrambling and modulation. The coded data stream is also referred to as a codeword and is equivalent to a transport block which is a data block provided by a MAC layer. One Transport Block (TB) is coded into one codeword and each codeword is transmitted to the receiving device in the form of one or more layers. For frequency up-conversion, the RF unit 13 may include an oscillator. The RF unit 13 may include Nₜ (where Nₜ is a positive integer) transmit antennas.

A signal processing process of the receiving device 20 is the reverse of the signal processing process of the transmitting device 10. Under control of the processor 21, the RF unit 23 of the receiving device 10 receives radio signals transmitted by the transmitting device 10. The RF unit 23 may include Nr receive antennas and frequency down-converts each signal received through receive antennas into a baseband signal. For frequency down-conversion, the RF unit 13 may include an oscillator. The processor 21 decodes and demodulates the radio signals received through the receive antennas and restores data that the transmitting device 10 originally desired to transmit.

The RF units 13 and 23 include one or more antennas. An antenna performs a function for transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. A signal transmitted through each antenna cannot be decomposed by the receiving device 20. A reference signal transmitted in correspondence to a corresponding antenna defines an antenna viewed from the receiving device 20 and enables the receiving device 20 to perform channel estimation for the antenna, irrespective of whether a channel is a single radio channel transmitted from one physical channel or a composite channel transmitted from a plurality of physical antennas including the antenna. That is, an antenna is defined such that a channel for transmitting a symbol on the antenna can be derived from the channel through which another symbol on the same antenna is transmitted. An RF unit supporting a Multiple Input Multiple Output (MIMO) function of transmitting and receiving data using a plurality of antennas may be connected to two or more antennas.

In the embodiments of the present invention, the UE operates as the transmitting device 10 in uplink and as the receiving device 20 in downlink. In the embodiments of the present invention, the eNB and HeNB operate as the receiving device 20 in uplink and operate as the transmitting device 10 in downlink.

Referring to FIG. 5 and FIG. 7, a processor of a UE (hereinafter, a UE processor) and/or a processor of a source eNB (hereinafter, a source eNB processor) may configure the UE to perform the proximity indication and/or positioning. The UE processor may control an RF unit of the UE (hereinafter, a UE RF unit) to receive information or messages, described in FIG. 5, transmitted by the source eNB and the target HeNB to the UE and may construct the information or messages, described in FIG. 5, to be transmitted by the UE to the source eNB and/or the target HeNB. The UE processor configures the UE RF unit to transmit the constructed information or messages to a corresponding eNB (i.e. the source eNB or the target HeNB). The UE processor may configure the UE or perform a proximity indication and/or positioning according to control of the HeNB. The UE may include a GPS receiver and the UE processor may perform positioning using the GPS receiver. For example, the UE processor may determine any one of the positions P1, P2, P3, and P4 of the UE at a positioning request of the source eNB. The UE processor may control the UE RF unit to transmit positioning information indicating one of the positions P1, P2, P3, and P4 to the source eNB. The UE processor may store proximity configuration information and/or positioning information in the memory of the UE. The UE processor may construct the proximity indication message (S04), the measurement report message (S06 and S09), and/or the HO complete message (S19) to include the positioning information indicting at least one of the positions P1, P2, P3, and P4 and control the UR RF unit to transmit the constructed message(s) to the source eNB.

Referring to FIG. 6 and FIG. 7, a UE processor and/or a processor of an eNB of a macro cell (hereinafter, a macro eNB processor) may configure the UE to perform a proximity indication and/or positioning. The UE processor may control a UE RF unit to receive information or messages transmitted by the macro eNB or an eNB of a femto cell (hereinafter, HeNB) to the UE and may construct the information or messages, described in FIG. 6, to be transmitted by the UE to the macro eNB and/or the HeNB. The UE processor configures the UE RF unit to transmit the constructed information or messages to a corresponding eNB (i.e. the source eNB or target HeNB). The UE processor may store proximity configuration information and/or positioning information in the memory of the UE. The UE processor may configure the UE or perform the proximity indication and/or positioning according to control of the macro eNB or HeNB. For example, if the UE RF unit receives a positioning request from the macro eNB or HeNB, the UE processor may determine any one of positions P5, P6, and P7 of the UE according to a positioning request. The UE processor may control the UE RF unit to transmit positioning information indicating at least one of P4, which has been measured while the UE enters the femto cell or proximity of the femto cell, and P5, P6, and P7, which have been measured while the UE leaves the femto cell or proximity of the femto cell, to the eNB transmitting the positioning request. The UE processor may construct the HO complete message (S25) and/or the proximity indication message (S27) to include the positioning information indicating at least one of P4, P5, P6, and P7 and control the UE RF unit to transmit the constructed message(s) to the eNB transmitting the positioning request.

Although, in FIG. 5 and FIG. 6, the embodiments of the present invention have been described using an HO procedure, the embodiments of the present invention may be applied even when the UE is handed over to a femto cell from a non-femto cell or is not handed over to the non-femto cell from the femto cell. That is, the embodiments of the present invention are applicable in the case in which the UE detects proximity of a femto cell.

According to the above-described embodiments of the present invention, information about coverage of a cell, which is difficult to be discerned by an operator because the cell is not deployed by the operator, can be provided to the operator. Accordingly, the embodiments of the present invention may be used for minimization of drive test (MDT). MDT refers to technology in which the operator measures quality of a cell using an automobile. Instead of a conventional method for performing a drive test, in the embodiments of the present invention, a UE measures the location of proximity of a cell which is not deployed by the operator and reports the position to the network, thereby minimizing time and costs consumed to optimize the network.

The detailed description of the preferred embodiments of the present invention has been given to enable those skilled in the art to implement and practice the invention. Although the invention has been described with reference to exemplary embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

### INDUSTRIAL APPLICABILITY

The present invention is applicable to a BS, a UE, or other equipment in a wireless communication system.

1. A method for transmitting, by a user equipment, positioning information to a network in a wireless communication system, comprising:
detecting proximity of a cell other than a cell (hereinafter, a serving cell) in which the user equipment stays;
acquiring position of the user equipment; and
transmitting positioning information indicating the acquired position to the network.

2. The method according to claim 1, wherein the serving cell is a cell deployed by a network operator and the cell other than the serving cell is a cell which is not deployed by the network operator.

3. The method according to claim 1, wherein the cell other than the serving cell is a closed subscriber group (CSG) cell.

4. The method according to claim 1, wherein the position is measured while the user equipment enters the proximity of the cell other than the serving cell or while the user equipment leaves the proximity of the cell other than the serving cell.

5. The method according to claim 4, wherein the positioning information is included in a proximity indication message, used to indicate that the user equipment enters or leaves the proximity of the cell other than the serving cell, to be transmitted to the network.

6. The method according to claim 1, further comprising:
receiving a positioning request from the network; and
transmitting the positioning information to the network via a base station of the serving cell as a response to the positioning request.

7. The method according to claim 1, wherein the positioning information is included in a proximity indication message, used to indicate that the user equipment enters or leaves the proximity of the cell other than the serving cell, to be transmitted to the network via a base station of the serving cell.

8. The method according to claim 1, wherein the positioning information includes at least one of a position of the user equipment when the user equipment detects the cell other than the serving cell, a position of the user equipment when the user equipment performs a measurement report to the network, and a position of the user equipment when the user equipment receives a handover command from the network.

9. A user equipment for transmitting positioning information to a network in a wireless communication system, comprising:
a radio frequency (RF) unit configured to transmit/receive a radio signal; and
a processor configured to control the RF unit,
wherein the processor controls the RF unit to detect proximity of a cell other than a cell (a serving cell) in which the user equipment stays, acquire position of the user equipment, and transmit positioning information indicating the acquired position to the network.

10. The user equipment according to claim 9, wherein the serving cell is a cell deployed by a network operator and the cell other than the serving cell is a cell which is not deployed by the network operator.

11. The user equipment according to claim 9, wherein the cell other than the serving cell is a closed subscriber group (CSG) cell.

12. The user equipment according to claim 9, wherein the user equipment measures the position while the user equipment enters the proximity of the cell other than the serving cell or while the user equipment leaves the proximity of the cell other than the serving cell.

13. The user equipment according to claim 12, wherein the positioning information is included in a proximity indication message, used to indicate that the user equipment enters or leaves the proximity of the cell other than the serving cell, to be transmitted to the network.

14. The user equipment according to claim 9, wherein the processor is configured to control the RF unit to receive a positioning request from the network; and control the RF unit to transmit the positioning information to the network via a base station of the serving cell as a response to the positioning request.

15. The user equipment according to claim 9, wherein the positioning information is included in a proximity indication message, used to indicate that the user equipment enters or leaves the proximity of the cell other than the serving cell, to be transmitted to the network via a base station of the serving cell.

16. The user equipment according to claim 9, wherein the positioning information includes at least one of a position of the user equipment when the user equipment detects the cell other than the serving cell, a position of the user equipment when the user equipment performs a measurement report to the network, and a position of the user equipment when the user equipment receives a handover command from the network.
